(19) United States
(12) Patent Application Publication
(10) Pub. No.: US 2010/0000073 A1
(43) Pub. Date: Jan. 7, 2010

(54) METHOD OF PRODUCING AT LEAST TWO PLANE FUNCTIONAL SURFACES EXTENDING PARALLEL TO EACH OTHER ON A PIPE

(75) Inventors: Kurt Steinhoff, Kleve (DE); Ursula Weidig, Kassel (DE); Klaus Hübner, Kassel (DE)

Correspondence Address: PYLE & PIONTEK, LLC, 221 N LASALLE STREET , ROOM 1207, CHICAGO, IL, 60601, US

(73) Assignee: ALSTOM TECHNOLOGY LTD., Baden (DE)

(21) Appl. No.: 12/310,326

(22) PCT Filed: Aug. 17, 2007
(86) PCT No.: PCT/DE2007/001467

§ 371 Date: Feb. 20, 2009

(30) Foreign Application Priority Data
Aug. 25, 2006 (DE) 10 2006 040 023.2

(51) Int. Cl. B23P 17/04

(52) U.S. Cl. 29/592

(57) ABSTRACT

The object of the invention is a method for producing at least two plane functional surfaces extending parallel to each other on a pipe (3) having a curved, such as round, or a polygonal cross-section wherein the length of each functional surface extends only across part of the length of the pipe (3) between two smooth cylindrical rollers (4, 5) disposed in a roller frame, wherein keeping with the desired two-dimensional extension of the functional surfaces the pipe (3) is guided, preferably multiple times, between the rollers in accordance with the desired degree of deformation.

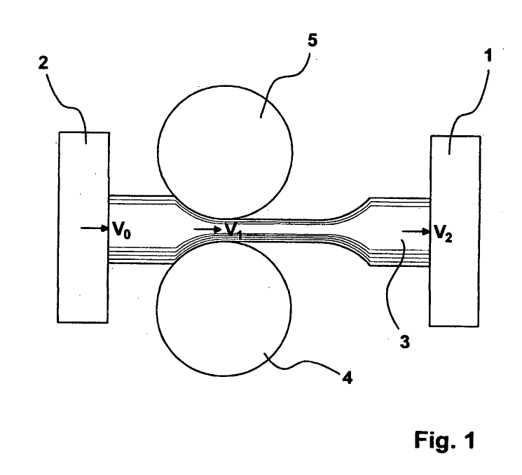

The present invention relates to a method of producing at least two plane functional surfaces extending parallel to each other on a pipe having a curved, e.g., round or polygonal cross section.

A pipe is generally understood to refer to an elongate, round or polygonal item that is hollow inside.

The subject matter of the invention now is a method of the type mentioned herein above by means of which a pipe of any cross-sectional shape may be applied on plane functional surfaces in order for example to screw or otherwise connect such a pipe to another item, which is at least plane in the region of the joint.

In this context, it has been known to manufacture such cross-sectional shapes with plane functional surfaces by forming them with profiled cylinders. Moreover, it is known to provide for such type functional surfaces on a hollow body such as pipes by means of internal high-pressure forming (IHP-forming). Using the IHP forming technique, a pressurized medium is applied to the interior of such a hollow body, which is either cold or has been heated, the hollow body being moulded through said medium into a cavity surrounding it. The disadvantage when forming with profiled cylinders is that each cross-sectional shape requires another cylinder geometry. In principle, the same applies to the IHP forming technique insofar as it requires a different cavity for each desired cross-sectional shape. In summary, this means that these methods are very complex since a separate cylinder or a separate cavity must be made for each cross-sectional shape.

It is therefore the object of the invention to provide a method of the type mentioned herein above by means of which production of plane functional surfaces of various type may be applied to elongate pipes having the most varied cross-sectional shapes at much lower cost.

As a solution to this problem, there is proposed, in accordance with the invention, a method of producing at least two plane functional surfaces extending parallel to each other on a pipe having a curved or a polygonal cross section, the length of the respective functional surface extending preferably over part of the pipe length, wherein there are provided two smooth cylindrical rolls disposed in a rolling stand, said pipe being fed between the rolls at least once, preferably several times, according to the desired planar extension of the functional surfaces and to the desired forming degree, with the rolls having at need different feeding degrees. It is obvious therefrom that a pipe machined in this way comprises two plane functional surfaces extending parallel to each other on two sides, whereas the side edges are arcuate like before.

To produce a polygonal cross section of a pipe, there is proposed, in accordance with the invention, to rotate the pipe an angle after one or several machining cycles in order to then feed the rotated pipe between the rolls at least once, again according to the desired forming degree. Again, the way of proceeding is such that machining occurs at first in an initial angular position, that then the machining is performed in the rotated condition, in order to then alternate between the two angular positions during machining, depending on the desired forming degree, the desired angle or edge configuration as well as finally the material properties due to the forming behavior.

Insofar, there is further provided that the pipe is fed between the rolls at different feeding of the rolls, i.e., at different gap height. The size of the roll feeding at each pass, i.e., at each passage of the pipe through the rolls, depends on the one side on the material and also on the temperature of the workpiece in the forming region and also depends on the desired forming degree.

According to another feature of the invention, there is provided that the pipe is heated in the region of the forming path. As the material is heated, the plasticity of the material changes, which in turn influences the number of passes to be repeated, i.e., the number of times the pipe is fed through the rolls.

According to another particular feature of the invention, there is provided that the pipe is compressed or is subjected to tensile load during forming, completely dependent on which cross-sectional shape is desired. On a pipe subjected to tensile load, the cross sectional surface area is reduced, the wall thickness in particular being minimized.

The number of feeds in the desired angular positions also determines the transition radius between the plane functional surfaces. Meaning, the higher the number of forming sequences in each angular position, the smaller finally the transition radius between the thus formed surfaces of the pipe.

The invention will be described in closer detail herein after with reference to the drawing.

The drawing only is a schematic illustration of the device. There are provided two mounts 1 and 2 between which the pipe 3 is non-rotatably clamped. This pipe 3 is reciprocated between the two rolls 4 and 5, two cases being distinguished. If the speed V₀>V₁=V₂, the pipe 3 is stretched, i.e., the wall thickness of the pipe will decrease during forming. If by contrast the speed V₀<V₁=V₂, the wall thickness will increase. On the pipe to be machined, the hottest zone is always located directly before the rolls are applied onto the workpiece. The reason therefor is that this is the zone which will be formed next.

1. A method of producing at least two plane functional surfaces extending parallel to each other on a pipe having a curved, e.g., a round or a polygonal cross section, wherein it is preferred that the length of the respective one of the functional surfaces only extends over part of the pipe length, between two smooth cylindrical rolls disposed in a rolling stand, said pipe being fed between the rolls at least once, preferably several times, depending on the desired planar extension of the functional surfaces and on the desired forming degree.

2. The method as set forth in claim 1,
characterized in
that, to produce a polygonal cross section, the pipe is rotated an angle and is fed at least once between the rolls in the rotated condition, again according to the desired forming degree.

3. The method as set forth in claim 1,
characterized in
that the pipe is fed between the rolls, with the rolls being set differently, i.e., at differing gap heights.

4. The method as set forth in claim 2,
characterized in
that, in order to produce a polygonal cross section, the pipe is rotated an angle ranging between 10° and 90°, starting from its initial position.

5. The method as set forth in claim 1,
characterized in
that the pipe is heated in the region of the forming path.

6. The method as set forth in claim 5,
characterized in
that the pipe is compressed during forming.

7. The method as set forth in claim 5,
characterized in
that the pipe is subjected to tensile load during forming.
